(19) United States
(12) Patent Application Publication
(10) Pub. No.: US 2024/0293733 A1
(43) Pub. Date: Sep. 5, 2024

(54) OPERATION DEVICE, OPERATION SYSTEM, AND OPERATION METHOD

(71) Applicant: SONY INTERACTIVE ENTERTAINMENT INC., Tokyo (JP)

(72) Inventors: Koichi Obana, Tokyo (JP); Manabu Ishioka, Tokyo (JP); Tetsugo Inada, Tokyo (JP); Hirotaka Yamamoto, Kanagawa (JP)

(21) Appl. No.: 18/258,811

(22) PCT Filed: Jan. 19, 2021
(86) PCT No.: PCT/JP2021/001600

§ 371 Date: Jun. 22, 2023

(51) Int. Cl. A63F 13/219; A63F 13/245; A63F 13/426; A63F 13/837; G06F 3/0346

(52) U.S. Cl. CPC A63F 13/219; A63F 13/245; A63F 13/426; A63F 13/837; G06F 3/0346

(57) ABSTRACT

An operation device (3A or 3B) configured to operate an aiming position in response to an operation by a user includes a first switching operation unit (36) configured to receive an operation to switch an operation mode of the operation device, a detection unit (37) configured to detect movement of the operation device, an aiming operation unit (321 or 331) configured to operate the aiming position in response to an operation by the user, and a mode switching unit (411 or 415) configured to switch, depending on an operation on the first switching operation unit, the operation mode to one of a first mode in which the aiming position is determined on the basis of movement of the operation device detected by the detection unit and a second mode in which the aiming position is determined on the basis of an operation on the aiming operation unit.

### TECHNICAL FIELD

The present disclosure relates to an operation device, an operation system, and an operation method.

### BACKGROUND ART

Hitherto, a gaming device has been known that includes a gun-shaped directional interface object and executes a game while calculating the aiming position of the directional interface object (for example, see PTL 1). To be specific, a gaming system described in PTL 1 includes a directional interface object that is operated by a user, an HMD (Head Mounted Display) that is worn by the user, a camera, and a computer. The HMD is connected to the computer and displays video games or other content. The camera captures images of an interactive environment including the user and the directional interface object. The computer analyzes the captured images obtained by the camera to determine the positions and movement of the user, the HMD, and the directional interface object, and proceeds the processing of games or the like on the basis of the positions and movement of these.

### CITATION LIST

### Patent Literature

[PTL 1]
JP-T-2019-522849

### SUMMARY

### Technical Problems

However, in the gaming system described in PTL 1, the computer determines the position and movement of the directional interface object on the basis of the captured image of the directional interface object obtained by the camera. That is, a camera configured to capture the directional interface object is required in the gaming system described in PTL 1. This tends to lead to a more complex configuration of the gaming system. Besides, to construct the gaming system described in PTL 1 by connecting a camera to a home game console, it is necessary to place the camera in the appropriate position, which makes the preparation for starting games cumbersome.

Thus, there has been a demand for an operation device that can determine the aiming position without requiring a complex configuration or a cumbersome operation.

### Solution to Problems

An operation device according to a first aspect of the present disclosure is an operation device configured to operate an aiming position in response to an operation by a user, the operation device including a first switching operation unit configured to receive an operation to switch an operation mode of the operation device, a detection unit configured to detect movement of the operation device, an aiming operation unit configured to operate the aiming position in response to an operation by the user, and a mode switching unit configured to switch, depending on an operation on the first switching operation unit, the operation mode to one of a first mode in which the aiming position is determined on the basis of movement of the operation device detected by the detection unit and a second mode in which the aiming position is determined on the basis of an operation on the aiming operation unit.

An operation system according to a second aspect of the present disclosure includes the above-mentioned operation device, and an information processing device that is operated by the operation device.

An operation method according to a third aspect of the present disclosure is an operation method that is performed by an operation device configured to operate an aiming position, the operation method including a first determination procedure of determining whether or not a first switching operation to switch an operation mode of the operation device has been performed, a first switching procedure of switching, when it is determined, in the first determination procedure, that the first switching operation has been performed, the operation mode of the operation device to one of a first mode in which the aiming position is determined on the basis of movement of the operation device, and a second mode in which the aiming position is determined on the basis of an operation by a user on an aiming operation unit provided on the operation device, and a second switching procedure of switching, when it is determined, in the first determination procedure, that the first switching operation has not been performed, the operation mode of the operation device to another mode of the first mode and the second mode.

### BRIEF DESCRIPTION OF DRAWINGS

FIG. 1 is a schematic diagram illustrating the configuration of an information processing system according to a first embodiment.

FIG. 2 is a schematic diagram illustrating an operation device according to the first embodiment.

FIG. 3 is a block diagram illustrating the configuration of the operation device according to the first embodiment.

FIG. 4 is a functional block diagram illustrating a control unit of the operation device according to the first embodiment.

FIG. 5 is a flowchart illustrating aiming operation processing according to the first embodiment.

FIG. 6 is a block diagram illustrating the configuration of an information processing device according to the first embodiment.

FIG. 7 is a schematic diagram illustrating an operation device according to a second embodiment.

FIG. 8 is a diagram illustrating a display area in a captured area according to the second embodiment.

FIG. 9 is a block diagram illustrating the configuration of the operation device according to the second embodiment.

FIG. 10 is a functional block diagram illustrating a control unit of the operation device according to the second embodiment.

FIG. 11 is a diagram illustrating an exemplary game screen displayed on a display device according to the second embodiment.

FIG. 12 is a diagram illustrating an exemplary captured image including a game screen according to the second embodiment.

FIG. 13 is a flowchart illustrating aiming operation processing according to the second embodiment.

### DESCRIPTION OF EMBODIMENTS

### First Embodiment

Now, a first embodiment of the present disclosure is described with reference to the drawings.

### [Configuration of Information Processing System]

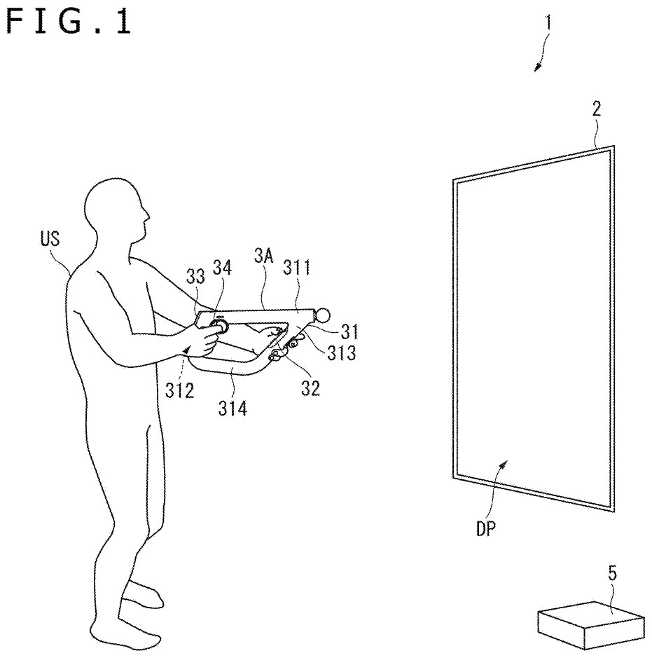

FIG. 1 is a schematic diagram illustrating the configuration of an information processing system 1 according to the present embodiment.

The information processing system 1 according to the present embodiment includes an operation system of the present disclosure. The information processing system 1 includes, as illustrated in FIG. 1, a display device 2, an operation device 3A, and an information processing device 5. The information processing device 5 executes predetermined processing in response to an operation by a user US on the operation device 3A, and the display device 2 displays the execution result. In the present embodiment, the information processing device 5 is configured to be capable of executing gun shooting games such as an FPS (First-person shooter). Then, the information processing device 5 acquires the aiming position of the operation device 3A in the screen displayed on the display device 2 and proceeds the gun shooting game on the basis of the acquired aiming position.

Now, each configuration of the information processing system 1 is described.

### [Configuration of Display Device]

The display device 2 is connected to the information processing device 5. The display device 2 has a display area DP for displaying images generated by the information processing device 5. The display device 2 displays images including the processing results by the information processing device 5, such as the images of screens of games being executed. In the present embodiment, the display device 2 displays a screen which is generated by the information processing device 5 and in which the aiming position is operated by the operation device 3A.

### [Configuration of Operation Device]

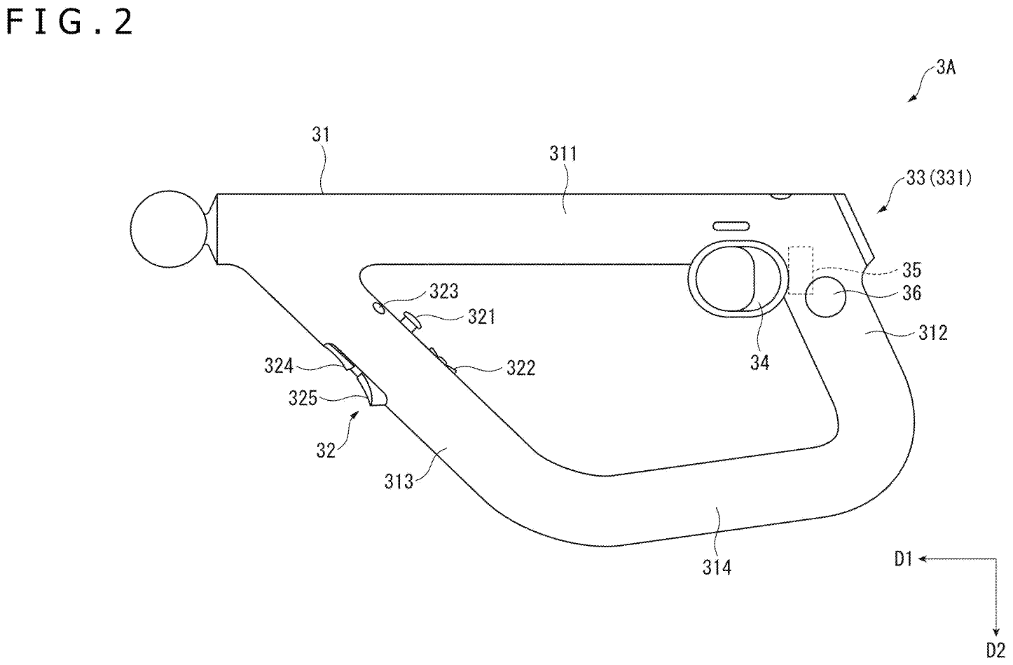

FIG. 2 is a schematic diagram illustrating the operation device 3A. Note that, in FIG. 2, a direction D1 is orthogonal to a direction D2. However, it is sufficient for the direction D1 and the direction D2 to intersect, and the direction D1 and the direction D2 are not necessarily orthogonal.

The operation device 3A operates the aiming position in response to an operation by the user. The operation device 3A includes, as illustrated in FIG. 2, a housing 31, a first operation unit 32, a second operation unit 33, a trigger 34, an operation detection unit 35, and a first switching operation unit 36.

The housing 31 forms the exterior of the operation device 3A and is a gun-shaped housing. To be specific, the housing 31 is formed in a shape like a rifle or a machine gun. That is, the operation device 3A is a gun-shaped operation device.

The housing 31 has a barrel 311, a grip 312, a foregrip 313, and a bridge 314, and is formed in a substantially parallelogram shape when viewed from the side.

The barrel 311 linearly extends in the direction D1. The barrel 311 is a part that corresponds to the barrel of a gun.

The grip 312 extends along the direction D2, which intersects the direction D1, from the end portion opposite to the direction D1 of the barrel 311. The grip 312 is a part that is held by one hand of the user US. The foregrip 313 extends along the direction D2 from the distal end portion in the direction D1 of the barrel 311. The foregrip 313 is a part that is held by one hand that is the other hand that does not hold the grip 312. For example, in a case where the grip 312 is held by the right hand, the foregrip 313 is held by the left hand. The bridge 314 is a part that connects the distal end portion in the direction D2 of the grip 312 to the distal end portion in the direction D2 of the foregrip 313. The bridge 314 extends substantially parallel to the barrel 311.

The first operation unit 32 is provided on the foregrip 313 and outputs control signals corresponding to operations by the user to a control unit 41A described later. The first operation unit 32 includes an aiming operation unit 321, a directional pad 322, buttons 323 and 324, and a trigger button 325.

The aiming operation unit 321, the directional pad 322, and the button 323 are provided on the surface facing the opposite direction from the direction D1 of the foregrip 313. The aiming operation unit 321 is a unit configured to operate the aiming position of the operation device 3A in response to an operation by the user, and is, for example, a cursor or an analog stick that supports aiming operations.

The button 324 and the trigger button 325 are provided on the surface facing the direction D1 of the foregrip 313. The trigger button 325 is configured like the trigger of a gun and configured to give the user pulling the trigger button 325 an operational feeling that is roughly the same as an operational feeling that he/she gets when pulling the trigger 34.

The second operation unit 33, a detailed illustration of which is omitted, is provided at the end portion opposite to the direction D1 of the barrel 311. The second operation unit 33 includes an aiming operation unit 331 like the aiming operation unit 321. That is, like the aiming operation unit 321, the aiming operation unit 331 is a unit configured to operate the aiming position of the operation device 3A in response to an operation by the user, and is, for example, an analog stick. The second operation unit 33 outputs control signals corresponding to operations by the user to the control unit 41A, like the first operation unit 32.

The trigger 34 is placed at the intersection of the barrel 311 and the grip 312. The trigger 34 is operated by the index finger of the hand holding the grip 312, for example.

The operation detection unit 35 is provided inside the housing 31 at a position corresponding to the trigger 34. When detecting that the trigger 34 has been operated, the operation detection unit 35 outputs a control signal indicating that the trigger 34 has been operated to the control unit 41A.

The first switching operation unit 36 is a button that can be operated by the thumb of the hand holding the grip 312, for example. The first switching operation unit 36 receives an operation to switch the operation mode of the operation device 3A. Specifically, the first switching operation unit 36 outputs a control signal to switch the operation mode of the operation device 3A to the control unit 41A, in response to an operation by the user. The switching of the operation mode by the control unit 41A is described in detail later.

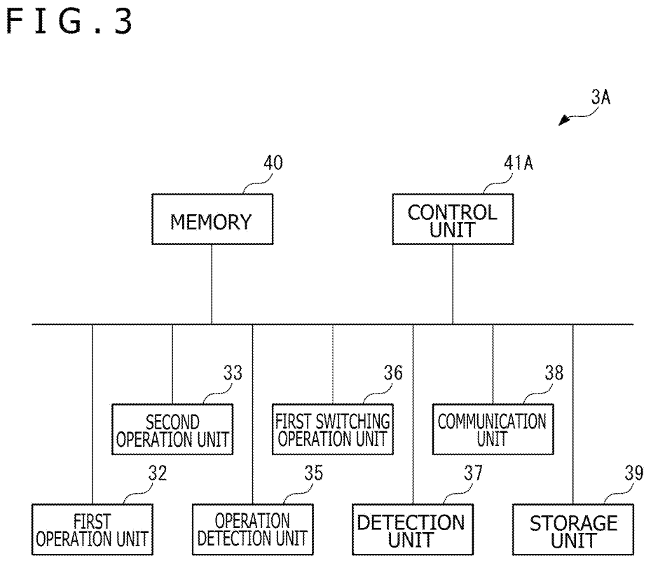

FIG. 3 is a block diagram illustrating the configuration of the operation device 3A.

The operation device 3A includes, in addition to the above-mentioned configuration, a detection unit 37, a communication unit 38, a storage unit 39, a memory 40, and the control unit 41A, as illustrated in FIG. 3. The detection unit 37 detects the movement of the operation device 3A. The detection unit 37 includes an acceleration sensor configured to detect three-axis acceleration and a gyro sensor configured to detect three-axis angular velocity. In other words, the detection unit 37 is a six-axis sensor that can detect three-axis acceleration and three-axis angular velocity. The detection unit 37 outputs the detected acceleration of each axis and three-axis angular velocity to the control unit 41A.

The communication unit 38 corresponds to a transmission unit of the present disclosure. The communication unit 38 communicates with external equipment under the control of the control unit 41A. The communication unit 38 communicates with the information processing device 5, for example. Note that the communication unit 38 can communicate with the information processing device 5 via a wired connection and a wireless connection. In a case where the operation device 3A is connected to the information processing device 5 wirelessly, the communication unit 38 communicates with the information processing device 5 using a communication protocol compliant with a short-range wireless communication standard such as Bluetooth (registered trademark). For example, the communication unit 38 transmits operation signals generated by the control unit 41A to the information processing device 5.

The storage unit 39 includes a non-volatile storage device such as a flash memory and stores programs and data necessary for the operation of the operation device 3A. For example, the storage unit 39 stores an aiming operation program for determining the aiming position operated by the operation device 3A and transmitting an operation signal indicating the coordinates of the aiming position.

The memory 40 is the working memory of the control unit 41A.

The control unit 41A includes an arithmetic processing unit such as a CPU (Central Processing Unit) and controls the operation of the operation device 3A. For example, when the control unit 41A receives a control signal indicating that the trigger 34 has been operated from the operation detection unit 35, the control unit 41A transmits an operation signal indicating that the trigger 34 has been operated to the information processing device 5 via the communication unit 38. Further, for example, the control unit 41A switches the operation mode of the operation device 3A depending on an operation by the user on the first switching operation unit 36 and transmits an operation signal indicating the coordinates of the aiming position in the display area DP to the information processing device 5 via the communication unit 38.

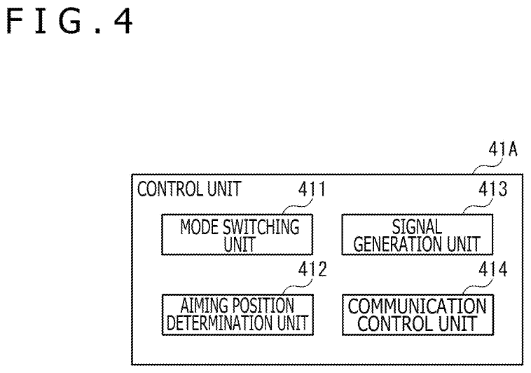

FIG. 4 is a functional block diagram illustrating the control unit 41A.

The control unit 41A includes, as illustrated in FIG. 4, a mode switching unit 411, an aiming position determination unit 412, a signal generation unit 413, and a communication control unit 414.

The mode switching unit 411 switches the operation mode of the operation device 3B depending on a switching operation on the first switching operation unit 36. Specifically, in a case where no switching operation is performed on the first switching operation unit 36, the mode switching unit 411 sets the operation mode of the operation device 3B to a first mode. Meanwhile, in a case where a switching operation is performed on the first switching operation unit 36, the mode switching unit 411 switches the operation mode of the operation device 3B to a second mode.

The first mode is an operation mode in which the aiming position is determined on the basis of the movement of the operation device 3A detected by the detection unit 37. Note that, in a case where the aiming position is determined in the first mode, calibration for adjusting the posture and orientation of the operation device 3A with respect to the display device 2 is performed in advance using the operation device 3A.

The second mode is an operation mode in which the aiming position is determined on the basis of operations by the user on the aiming operation units 321 and 331. Note that, in a case where the aiming position is determined in the second mode, setting information including, for example, the resolution of the display area DP, the range of aiming movement in the display area DP, and the speed of aiming movement in the display area DP, is acquired from the information processing device 5 by the operation device 3A, or is acquired on the basis of input operations by the user on the first operation unit 32 and the second operation unit 33.

The aiming position determination unit 412 determines the aiming position on the basis of the operation mode switched by the mode switching unit 411. In the present embodiment, the aiming position determination unit 412 determines the coordinate value of the aiming position in the display area DP.

In a case where the operation mode of the operation device 3A is the first mode, the aiming position determination unit 412 estimates the posture and orientation of the operation device 3A with respect to the display area DP from the movement of the operation device 3A detected by the detection unit 37 and determines the coordinate value of the aiming position in the display area DP on the basis of the estimated posture and orientation of the operation device 3A.

In a case where the operation mode of the operation device 3A is the second mode, the aiming position determination unit 412 determines the coordinate value of the aiming position that is moved in the display area DP on the basis of operations by the user on the aiming operation units 321 and 331.

The signal generation unit 413 generates an operation signal that is a signal indicating the coordinate value of the aiming position determined by the aiming position determination unit 412.

The communication control unit 414 controls communication with external equipment via the communication unit 38 and transmits and receives information to and from the external equipment. For example, the communication control unit 414 transmits operation signals generated by the signal generation unit 413 to the information processing device 5 via the communication unit 38. Further, the communication control unit 414 acquires necessary information, such as the above-mentioned setting information, from the information processing device 5 via the communication unit 38.

### [Aiming Operation Processing]

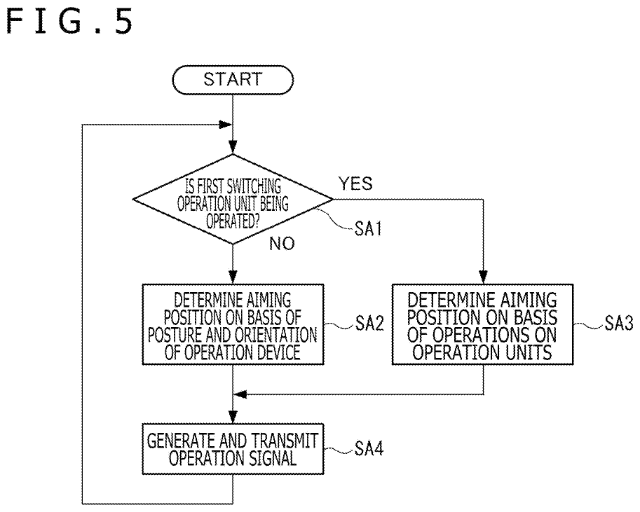

FIG. 5 is a flowchart illustrating aiming operation processing that is performed by the control unit 41A.

The control unit 41A performs the aiming operation processing illustrated in FIG. 5 on the basis of the aiming operation program stored in the storage unit 39. The aiming operation processing is processing of operating the aiming position in a game executed by the information processing device 5 by determining the aiming position of the operation device 3A operated by the user and transmitting an operation signal indicating the determined aiming position to the information processing device 5. That is, the aiming operation processing is processing that includes an operation method of the present disclosure.

In the aiming operation processing, first, the mode switching unit 411 determines whether or not an operation on the first switching operation unit 36 (first switching operation) has been performed (Step SA1). Specifically, in Step SA1, the mode switching unit 411 determines whether or not the button of the first switching operation unit 36 has been pressed. Step SA1 corresponds to a first determination procedure.

In a case where it is not determined, in the determination processing of Step SA1, that an operation has been performed on the first switching operation unit 36, that is, in a case where no operation has been performed on the first switching operation unit 36 (Step SA1: NO), the mode switching unit 411 sets the operation mode of the operation device 3A to the first mode (second switching procedure). When the operation mode is the first mode, the aiming position determination unit 412 estimates the posture and orientation of the operation device 3A with respect to the display area DP on the basis of the movement of the operation device 3A detected by the detection unit 37 and determines the coordinate value of the aiming position in the display area DP as described above (Step SA2). After Step SA2, the control unit 41A proceeds the processing to Step SA4.

In a case where it is determined, in the determination processing of Step SA1, that an operation has been performed on the first switching operation unit 36, that is, in a case where the first switching operation unit 36 has been pressed (Step SA1: YES), the mode switching unit 411 switches the operation mode of the operation device 3A to the second mode (first switching procedure). When the operation mode is the second mode, the aiming position determination unit 412 determines the coordinate value of the aiming position on the basis of operations by the user on the aiming operation units 321 and 331 (Step SA3). After Step SA3, the control unit 41A proceeds the processing to Step SA4.

In Step SA4, the signal generation unit 413 generates an operation signal indicating the determined coordinate value of the aiming position, and the communication control unit 414 transmits the generated operation signal to the information processing device 5 via the communication unit 38 (Step SA4). After Step SA4, the control unit 41A returns the processing to Step SA1.

In this way, the aiming operation processing is repeatedly executed by the control unit 41A, and operation signals corresponding to user operations to change the posture and orientation of the operation device 3A or operations by the user on the aiming operation units 321 and 331 are transmitted to the information processing device 5. With this, the information processing device 5 moves the aiming position in the execution screen, such as a game screen, displayed in the display area DP.

### [Configuration of Information Processing Device]

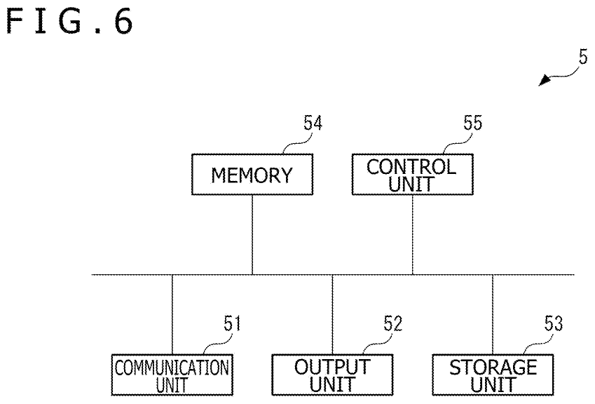

FIG. 6 is a block diagram illustrating the configuration of the information processing device 5.

The information processing device 5 executes the processing of games or the like in response to operations by the user on the operation device 3A as described above. That is, the information processing device 5 is operated by the operation device 3A. For example, the information processing device 5 executes a gun shooting game and moves the aiming position in the game screen on the basis of operation signals received from the operation device 3A. Such an information processing device 5 includes, as illustrated in FIG. 6, a communication unit 51, an output unit 52, a storage unit 53, a memory 54, and a control unit 55.

The communication unit 51 communicates with external equipment such as the operation device 3A and transmits and receives information to and from the external equipment. That is, the communication unit 51 has the function of a reception unit configured to receive operation signals from the operation device 3A. The communication unit 51 outputs signals received from the external equipment to the control unit 55. Further, the communication unit 51 can be connected to networks such as the Internet via relay devices such as routers and can communicate with servers on the networks.

The output unit 52 is connected to the display device 2. The output unit 52 outputs image signals generated by the control unit 55 to the display device 2, thereby allowing the display device 2 to display images corresponding to the image signals.

The storage unit 53 stores programs and data necessary for the operation of the information processing device 5. For example, the storage unit 53 stores an OS (Operating System) configured to manage the information processing device 5. Further, for example, the storage unit 53 stores game programs that can be operated by the operation device 3A.

The memory 54 is the working memory of the control unit 55.

The control unit 55 executes the OS stored in the storage unit 53 to control the operation of the information processing device 5 and to execute games selected by the user. When the control unit 55 executes a gun shooting game, the control unit 55 proceeds the game on the basis of operation signals received from the operation device 3A via the communication unit 51.

For example, in a case where an operation signal indicating that the trigger 34 has been operated is received, the control unit 55 determines whether a bullet or the like has hit an object on the basis of the current aiming position and the position of the object on the game screen.

Further, for example, in a case where an operation signal indicating the coordinate value of the aiming position is received, the control unit 55 moves the aiming position in the game screen on the basis of the received operation signal.

### [Effect of First Embodiment]

The information processing system 1 according to the present embodiment described above achieves the following effects.

The information processing system 1 corresponds to an operation system. The information processing system 1 includes the operation device 3A and the information processing device 5 that is operated by the operation device 3A.

The operation device 3A is an operation device configured to operate the aiming position in response to an operation by the user US. The operation device 3A includes the first switching operation unit 36, the detection unit 37, the aiming operation units 321 and 331, and the mode switching unit 411. The first switching operation unit 36 receives an operation to switch the operation mode of the operation device 3A. The detection unit 37 detects the movement of the operation device 3A.

The aiming operation units 321 and 331 operate the aiming position in response to operations by the user US. The mode switching unit 411 switches, depending on an operation on the first switching operation unit 36, the operation mode of the operation device 3A to one of the first mode in which the aiming position is determined on the basis of the movement of the operation device 3A detected by the detection unit 37, and the second mode in which the aiming position is determined on the basis of operations on the aiming operation units 321 and 331.

With such a configuration, the aiming position can be determined on the basis of the movement of the operation device detected by the detection unit 37, and the aiming position can also be determined on the basis of operations on the aiming operation units 321 and 331.

With this, there is no need to provide an imaging device for acquiring the posture of the operation device 3A and the relative orientation between the operation device 3A and the display device 2 by imaging the operation device 3A. Thus, the aiming position can be determined without requiring complex configuration or operation. Then, an operation signal indicating the determined aiming position is transmitted by the operation device 3A, and the operated aiming position can thus be grasped by the information processing device 5 that has received the operation signal.

The operation device 3A includes the signal generation unit 413 configured to generate an operation signal indicating the coordinate value of the aiming position determined by the aiming position determination unit 412, and the communication unit 38 configured to transmit operation signals generated by the signal generation unit 413. The communication unit 38 corresponds to the transmission unit.

With such a configuration, the information processing device 5, which is external equipment different from the operation device 3A, can grasp the aiming position operated by the operation device 3A by receiving the transmitted operation signal.

The information processing system 1 includes the display device 2. The display device 2 displays a screen such as a game screen which is generated by the information processing device 5 and in which the aiming position is operated by the operation device 3A.

With such a configuration, by acquiring the aiming position determined by the operation device 3A, for example, the information processing device 5 can cause the display device 2 to display an aiming marker indicating the aiming position. Thus, the versatility of the information processing system 1 can be enhanced.

### Second Embodiment

Next, a second embodiment of the present disclosure is described.

An information processing system according to the present embodiment has a configuration similar to that of the information processing system 1 according to the first embodiment but differs from the information processing system 1 in that an operation device further includes other configurations for determining the aiming position. Note that, in the following description, the same or substantially the same parts as those already described are denoted by the same reference signs, and the description thereof is omitted.

### [Outline Configuration of Information Processing System]

The information processing system according to the present embodiment has similar configuration and functions to the information processing system 1 according to the first embodiment, except for including an operation device 3B instead of the operation device 3A. That is, the information processing system according to the present embodiment is a system that includes the operation system of the present disclosure, and includes the display device 2, the operation device 3B, and the information processing device 5.

### [Configuration of Operation Device]

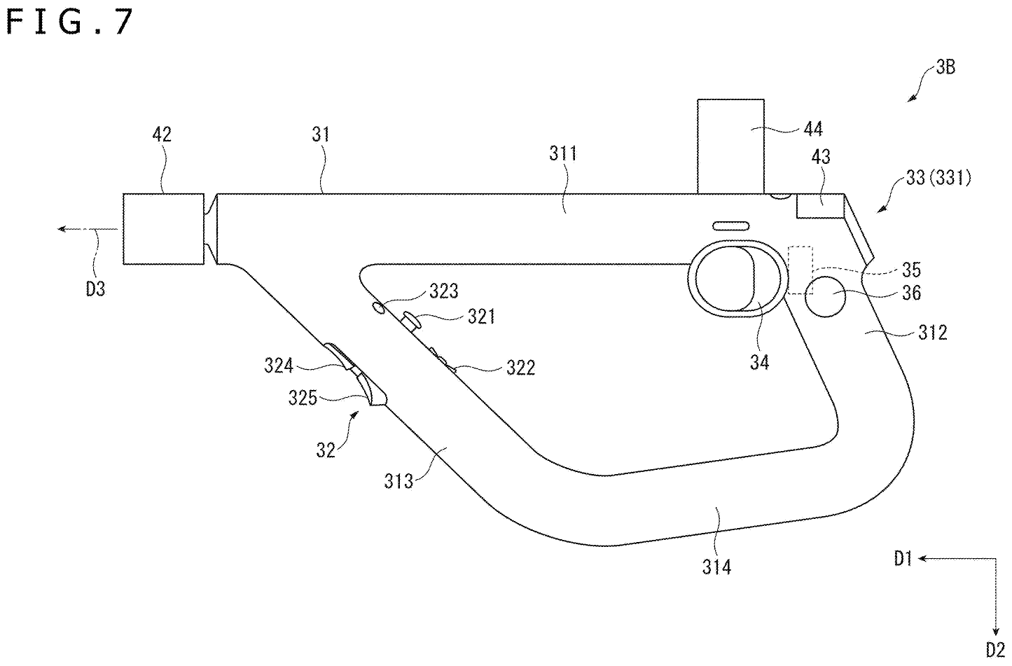

FIG. 7 is a schematic diagram illustrating the operation device 3B.

The operation device 3B transmits operation signals to operate the information processing device 5, like the operation device 3A. The operation device 3B includes, as illustrated in FIG. 7, an imaging unit 42, a second switching operation unit 43, and a display unit 44, in addition to similar configurations to the operation device 3A according to the first embodiment.

The imaging unit 42 captures the area in which the aiming position is set by the gun-shaped operation device 3B. For example, when the operation device 3B is directed toward the display area DP of the display device 2, the imaging unit 42 captures the area including the display area DP. The imaging unit 42 is provided at the distal end portion in the direction D1 of the barrel 311 such that the imaging direction (direction D3) of the imaging unit 42 extends along the extending direction (direction D1) of the barrel 311. In the present embodiment, the direction D3 is parallel to the direction D1. The imaging unit 42 outputs the captured image to a control unit 41B. The imaging unit 42 can include a CCD (Charge Coupled Device) image sensor or a CMOS (Complementary Metal Oxide Semiconductor) image sensor.

The second switching operation unit 43 receives an operation to switch the operation mode of the operation device 3B.

In the present embodiment, the second switching operation unit 43 includes a proximity sensor configured to detect the user. The second switching operation unit 43 recognizes, as an operation mode switching operation, the movement of the user bringing his/her face closer to the proximity sensor, that is, the movement of the user observing the display unit 44, and outputs, in a case where the switching operation is performed, a control signal to switch the operation mode of the operation device 3B to a third mode to the control unit 41B. The movement of the user observing the display unit 44 is more specifically the movement of the user looking into the display unit 44. Note that, the third mode is described in detail later.

The second switching operation unit 43 is provided in the vicinity of the display unit 44. To be specific, the second switching operation unit 43 is provided at the intersection of the barrel 311 and the grip 312 of the housing 31 and at a position in the vicinity of the display unit 44 on both side surfaces that intersect each of the direction D1 and the direction D2.

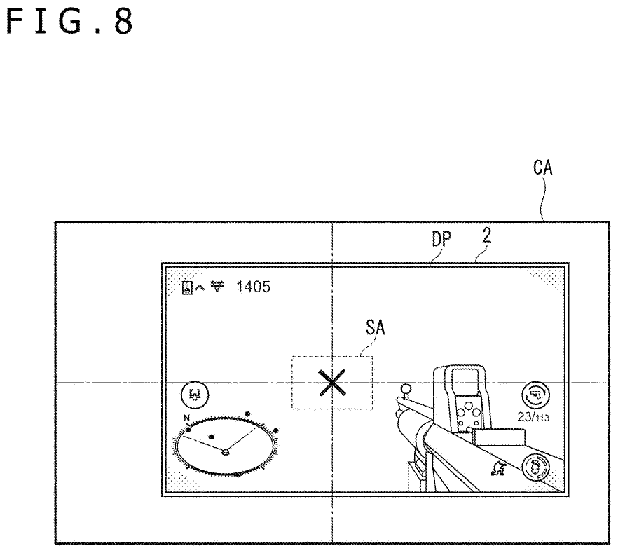

FIG. 8 is a diagram illustrating the display area DP displayed by the display unit 44 in a captured area CA obtained by the imaging unit 42.

The display unit 44 is provided at the end portion opposite to the direction D1 of the barrel 311 so as to protrude in a direction opposite to the direction D2. That is, the display unit 44 is provided at a part that corresponds to the rear sight of a gun. The display unit 44 displays the image of at least a part of the captured area obtained by the imaging unit 42 under control of the control unit 41B. For example, the display unit 44 displays, as illustrated in FIG. 8, the image of an aiming area SA that includes the center of the captured area CA and is smaller than the captured area CA in the captured area CA obtained by the imaging unit 42. That is, the display unit 44 displays at least a part of the captured image obtained by the imaging unit 42. Since the center of the captured area CA corresponds to the aiming position, with the image of the aiming area SA displayed by the display unit 44, it is possible to make it easier for the user to grasp the aiming position of the operation device 3B.

Further, the image displayed by the display unit 44 may be an image in which the luminance or color of the area outside the aiming area SA is changed in the captured area CA obtained by the imaging unit 42. In a case where such an image is displayed, it is possible to make it easier to grasp the aiming position of the operation device 3B, and the situation in the area outside the aiming area SA in the captured area CA can be confirmed on the display unit 44.

Meanwhile, the image displayed by the display unit 44 may be the captured image obtained by the imaging unit 42 itself.

Note that the use of the display unit 44 may be limited to when the operation mode of the operation device 3B is the third mode.

### [Other Configurations of Operation Device]

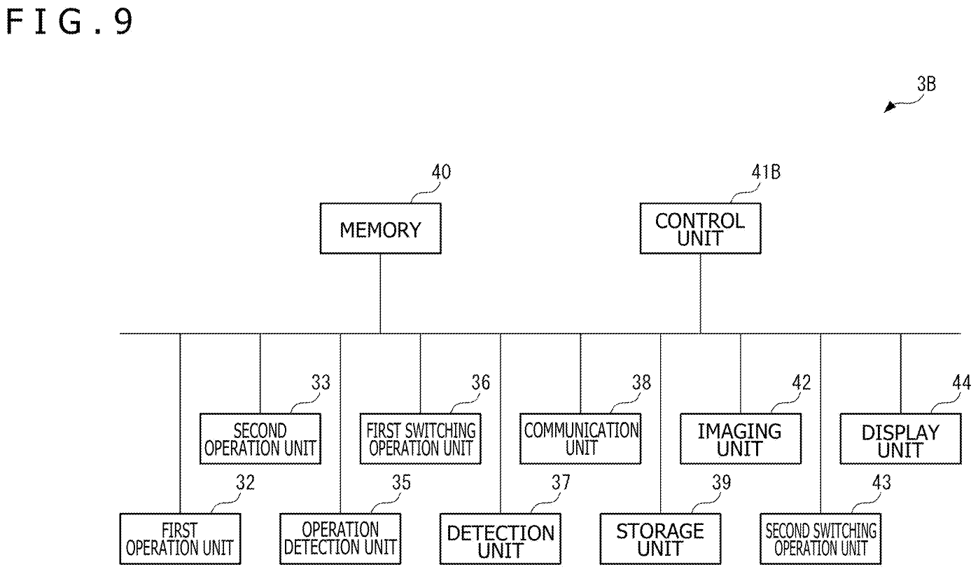

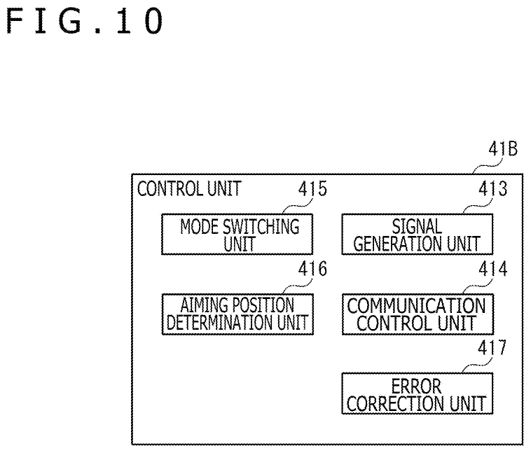

FIG. 9 is a block diagram illustrating the configuration of the operation device 3B. FIG. 10 is a functional block diagram illustrating the control unit 41B.

The operation device 3B includes the control unit 41B instead of the control unit 41A, as illustrated in FIG. 9.

The control unit 41B controls the operation of the operation device 3B, like the control unit 41A. The control unit 41B includes, as illustrated in FIG. 10, the signal generation unit 413, the communication control unit 414, a mode switching unit 415, an aiming position determination unit 416, and an error correction unit 417.

The mode switching unit 415 switches the operation mode of the operation device 3B depending on switching operations on the first switching operation unit 36 and the second switching operation unit 43. Specifically, in a case where no switching operation is performed on the first switching operation unit 36 and the second switching operation unit 43, the mode switching unit 411 sets the operation mode of the operation device 3B to the first mode described above. In a case where a switching operation is performed on the first switching operation unit 36, the mode switching unit 415 switches the operation mode of the operation device 3B to the second mode described above. In a case where a switching operation is performed on the second switching operation unit 43, that is, in a case where the movement of the user observing the display unit 44 is detected by the second switching operation unit 43, the mode switching unit 415 switches the operation mode of the operation device 3B to the third mode.

The third mode is an operation mode in which the aiming position of the operation device 3B is determined on the basis of the captured image obtained by the imaging unit 42.

In this way, the mode switching unit 415 switches the operation mode of the operation device 3B to the third mode in a case where the second switching operation unit 43 is operated, and switches the operation mode of the operation device 3B to one of the first mode and the second mode depending on an operation on the first switching operation unit 36 in a case where the second switching operation unit 43 is not operated.

The aiming position determination unit 416 determines the coordinate value of the aiming position in the display area DP of the display device 2 on which execution screens such as game screens are displayed, on the basis of the operation mode switched by the mode switching unit 415.

In a case where the operation mode is the first mode or the second mode, the aiming position determination unit 416 determines a coordinate value indicating the aiming position in the screen of the display device 2, like the aiming position determination unit 412.

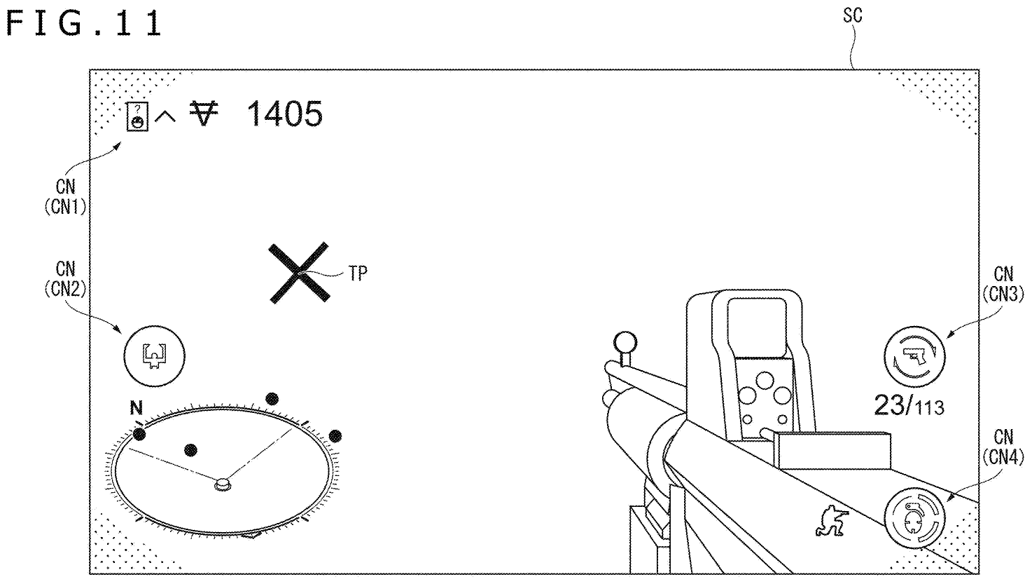

FIG. 11 is a diagram illustrating an example of a game screen SC displayed on the display device 2 by the information processing device 5.

In a case where the operation mode is the third mode, the aiming position determination unit 416 determines the coordinate value of the aiming position in the display area DP on the basis of the captured image obtained by the imaging unit 42, in which the position of the captured area CA is changed depending on the posture and orientation of the operation device 3B.

For example, the display device 2 displays the game screen SC illustrated in FIG. 11.

Here, the game screens of gun shooting games such as an FPS typically include the player's status, icons indicating owned weapons, the player's direction of movement, and a plurality of icons displaying the score and the like. For example, the game screen SC illustrated in FIG. 11 includes four icons CN (CN1 to CN4). The positions of a plurality of icons on the game screen are determined in advance for each game. Thus, with at least three icons being set as recognition markers, the position of the display area DP can be defined on the basis of the position of each recognition marker in the captured image. Further, since the imaging direction of the imaging unit 42 extends along the extending direction of the barrel 311, the center of the captured area CA obtained by the imaging unit 42 can be regarded as the aiming position of the operation device 3B.

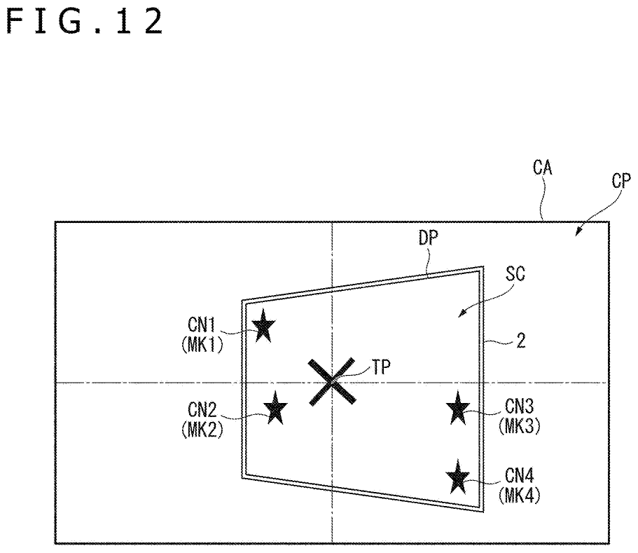

FIG. 12 is a diagram illustrating an example of a captured image CP including the game screen SC, which has been captured by the imaging unit 42.

Thus, as illustrated in FIG. 12, the aiming position determination unit 416 recognizes, from the captured image CP obtained by the imaging unit 42, the four icons CN1 to CN4 in the game screen SC displayed in the display area DP as recognition markers MK1 to MK4, and determines the coordinate range of the display area DP in the captured image CP on the basis of the positions of the recognition markers MK1 to MK4. Next, the aiming position determination unit 416 determines the coordinate value of an aiming position TP in the game screen SC on the basis of the coordinate range of the display area DP and the center position of the captured image CP (captured area CA).

Note that, the signal generation unit 413 generates an operation signal indicating the coordinate value of the aiming position in the display area DP determined by the aiming position determination unit 416 as described above.

Further, the communication control unit 414 transmits the operation signal generated by the signal generation unit 413, for example, to the information processing device 5 via the communication unit 38.

The error correction unit 417 functions in a case where the operation mode of the operation device 3B is not the first mode in which the aiming position is determined on the basis of the detection result by the detection unit 37. That is, the error correction unit 417 functions in a case where the operation mode of the operation device 3B is the second mode or the third mode. The error correction unit 417 corrects the error, specifically, the drift error of the gyro sensor included in the detection unit 37.

In a case where the imaging unit 42 is a monocular camera, the following error correction method is exemplified.

As the first step, the error correction unit 417 recognizes the recognition markers MK1 to MK4 from the captured image obtained by the imaging unit 42, and calculates the relative position between the display area DP of the display device 2 and the operation device 3B, and the posture of the operation device 3B with respect to the display area DP.

As the second step, the error correction unit 417 updates the relative position between the display area DP and the operation device 3B, and the posture of the operation device 3B with respect to the display area DP, on the basis of the detection results by the gyro sensor and the acceleration sensor included in the detection unit 37.

As the third step, the error correction unit 417 recognizes the recognition markers MK1 to MK4 again from the captured image obtained by the imaging unit 42, and integrates the relative position between the display area DP and the operation device 3B and the posture of the operation device 3B with respect to the display area DP based on the detection results by the gyro sensor and the acceleration sensor included in the detection unit 37 with the relative position between the display area DP and the operation device 3B and the posture of the operation device 3B with respect to the display area DP derived from the captured image, to thereby correct the drift error of the gyro sensor. The relative position and posture based on the captured image may be integrated with the relative position and posture based on the detection result by the detection unit 37 using algorithms such as Kalman filters. In this case, on the basis of the position and posture estimation result based on the detection results by the gyro sensor and the acceleration sensor, which has the variance of noise or the like, and the position and posture estimation result based on the recognition markers MK1 to MK4 recognized from the captured image obtained by the image sensor, which has the variance of recognition accuracy or the like, a position and posture estimation result with a variance smaller than the variances of the two, that is, a more accurate position and posture estimation result, is calculated.

Note that, in a case where the imaging unit 42 is a monocular camera, it cannot distinguish between a case where the small display area DP is captured from up close and a case where the large display area DP is captured from far away. Thus, it is necessary to take measures such as having the user input the size of the display area DP or associating coordinate differences with absolute movement amounts using the detection results by the acceleration sensor.

In a case where the imaging unit 42 is a stereo camera, for example, the sensor fusion processing described in the first to third steps described above is repeatedly performed to correct the drift error of the gyro sensor. Along with this, SLAM (Simultaneous Localization and Mapping) is executed to create a map of the space in which the display device 2 is placed.

Note that, since the absolute coordinates in the space are determined by executing SLAM, it is also possible to correct the drift error of the gyro sensor every time the posture of the operation device 3B is changed.

Although the correction of the drift error of the gyro sensor by the error correction unit 417 has been described above, it is not necessary to employ the correction method described above. For example, the error correction unit 417 may prevent the accumulation of drift errors by periodically resetting the gyro sensor during game execution.

### [Aiming Operation Processing]

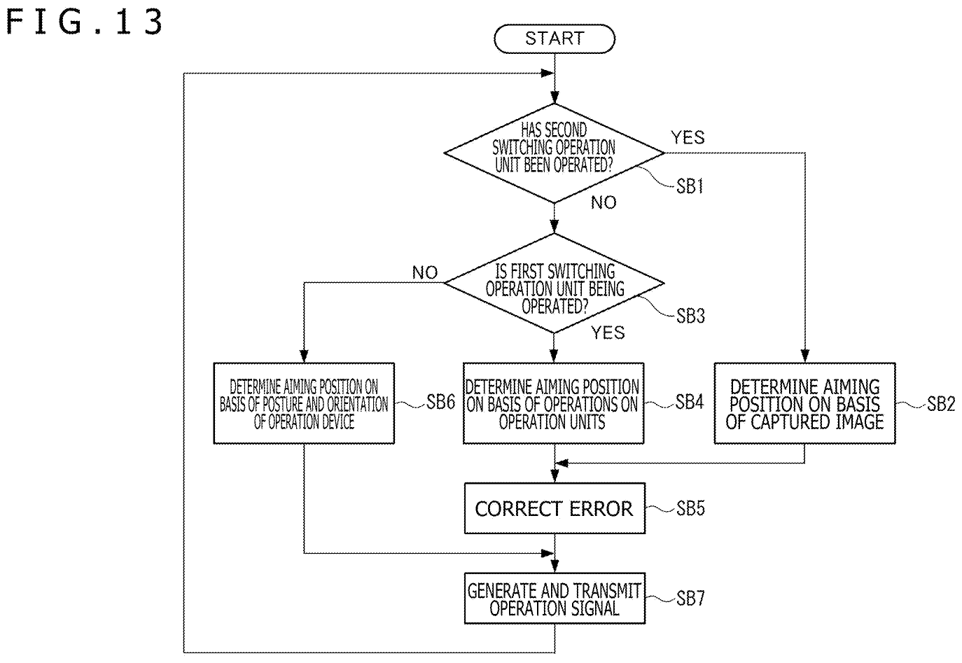

FIG. 13 is a flowchart illustrating aiming operation processing that is performed by the control unit 41B. The control unit 41B performs the aiming operation processing illustrated in FIG. 13 on the basis of the aiming operation program stored in the storage unit 39.

Like the aiming operation processing described in the first embodiment, the aiming operation processing is processing of operating the aiming position in a game executed by the information processing device 5 by determining the coordinate value of the aiming position of the operation device 3A operated by the user and transmitting an operation signal indicating the determined coordinate value of the aiming position to the information processing device 5. The aiming operation processing of the present embodiment is also processing that includes the operation method of the present disclosure.

In the aiming operation processing of the present embodiment, first, the mode switching unit 415 determines whether or not an operation on the second switching operation unit 43 (second switching operation) has been performed (Step SB1). Specifically, in Step SB1, the mode switching unit 415 determines whether or not the proximity sensor of the second switching operation unit 43 has detected the user. Step SB1 corresponds to a second determination procedure.

In a case where it is determined, in the determination processing of Step SB1, that an operation has been performed on the second switching operation unit 43, that is, in a case where the second switching operation unit 43 has detected the user (Step SB1: YES), the mode switching unit 415 switches the operation mode of the operation device 3B to the third mode (third switching procedure). In a case where the operation mode of the operation device 3B is the third mode, the aiming position determination unit 416 determines the coordinate value of the aiming position on the basis of the captured image obtained by the imaging unit 42 (Step SB2). Further, in a case where the operation mode of the operation device 3B is the third mode, the control unit 41B performs a display procedure of causing the display unit 44 to display at least a part of the captured image obtained by the imaging unit 42.

After Step SB2, the control unit 41B proceeds the processing to Step SB5.

In a case where it is not determined, in the determination processing of Step SB1, that an operation has been performed on the second switching operation unit 43, that is, in a case where the second switching operation unit 43 has not detected the user (Step SB1; NO), the mode switching unit 415 determines whether or not the first switching operation unit 36 has been operated (Step SB3), as in Step SA1 described above. Step SB3 corresponds to the first determination procedure.

In a case where it is determined, in the determination processing of Step SB3, that an operation has been performed on the first switching operation unit 36 (Step SB3: YES), as in Step SA3, the mode switching unit 415 switches the operation mode of the operation device 3B to the second mode (first switching procedure). In a case where the operation mode of the operation device 3B is the second mode, the aiming position determination unit 416 determines the coordinate value of the aiming position in the display area DP on the basis of operations by the user on the aiming operation units 321 and 331 (Step SB4). After Step SB4, the control unit 41B proceeds the processing to Step SB5.

In Step SB5, the error correction unit 417 corrects the drift error of the gyro sensor included in the detection unit 37 (Step SB5). After Step SB5, the control unit 41B proceeds the processing to Step SB7.

In a case where it is determined, in the determination processing of Step SB3, that no operation has been performed on the first switching operation unit 36 (Step SB3: NO), as in Step SA2, the mode switching unit 415 sets the operation mode of the operation device 3B to the first mode (second switching procedure). In a case where the operation mode of the operation device 3B is the first mode, the aiming position determination unit 416 determines the coordinate value of the aiming position in the display area DP on the basis of the movement of the operation device 3B detected by the detection unit 37 (Step SB6). After Step SB6, the control unit 41B proceeds the processing to Step SB7.

In Step SB7, as in Step SA4, the signal generation unit 413 generates an operation signal indicating the determined coordinate value of the aiming position, and the communication control unit 414 transmits the generated operation signal to the information processing device 5 via the communication unit 38 (Step SB7). After Step SB7, the control unit 41B returns the processing to Step SB1.

In this way, the aiming operation processing is repeatedly executed by the control unit 41B, and operation signals corresponding to user operations to change the posture and orientation of the operation device 3B or operations by the user on the aiming operation units 321 and 331 are transmitted to the information processing device 5. With this, the information processing device 5 moves the aiming position TP (see FIG. 12) in the execution screen such as a game screen.

### [Effect of Second Embodiment]

The information processing system according to the present embodiment described above achieves the following effects, in addition to effects similar to those of the information processing system 1 according to the first embodiment.

The operation device 3B includes the imaging unit 42 and the second switching operation unit 43. The imaging unit 42 captures the display area DP that is the area in which the aiming position is set. The second switching operation unit 43 receives an operation to switch the operation mode of the operation device 3B. The mode switching unit 415 switches, when the second switching operation unit 43 is operated, the operation mode to the third mode in which the coordinate value of the aiming position is determined on the basis of the captured image obtained by the imaging unit 42. The mode switching unit 415 switches, when the second switching operation unit 43 is not operated, the operation mode to one of the first mode and the second mode depending on an operation on the first switching operation unit 36.

With such a configuration, the aiming position is determined on the basis of the captured image obtained by the imaging unit 42, so that the aiming position can be determined with high accuracy.

The operation device 3B includes the display unit 44 configured to display at least a part of the captured image obtained by the imaging unit 42.

With such a configuration, it is possible to make it easier for the user to recognize the aiming position operated by the user US by changing the posture and orientation of the operation device 3B. Thus, the usability of the operation device 3B can be enhanced.

In the operation device 3B, the second switching operation unit 43 includes a proximity sensor provided in the vicinity of the display unit 44 and configured to detect the user. The mode switching unit 415 switches the operation mode of the operation device 3B to the third mode when the movement of the user observing the display unit 44 is detected by the second switching operation unit 43.

With such a configuration, the second switching operation unit 43 can regard the movement of the user looking into the display unit 44 as the movement of the user looking into the rear sight of a gun and recognize the movement as an operation to switch the operation mode of the operation device 3B to the third mode in which the imaging unit 42 configured to capture an image, a part of which is displayed on the display unit 44, is used. Then, in a case where the operation is performed on the second switching operation unit 43, the operation mode of the operation device is switched to the third mode, which makes it possible to operate the operation device 3B as if using an actual gun. Thus, the usability of the operation device 3B can be enhanced.

The operation device 3B includes the gun-shaped housing 31 configured to form the exterior of the operation device 3B. The imaging unit 42 is provided on the barrel 311 of the housing 31 such that the imaging direction (direction D3) of the imaging unit 42 extends along the extending direction (direction D1) of the barrel 311. With such a configuration, it is possible to make it easier to match the aiming position determined on the basis of the captured image obtained by the imaging unit 42 with the aiming position recognized by the user on the basis of the shape of the operation device 3B. That is, it is possible to make it easier for the user to intuitively operate the operation device 3B when moving the aiming position. Thus, the usability of the operation device 3B can be enhanced.

The operation device 3B includes the error correction unit 417 configured to correct the error of the gyro sensor included in the detection unit 37 when the operation mode of the operation device 3B is not the first mode.

With such a configuration, in a case where the operation mode of the operation device 3B is not the second mode in which the coordinate value of the aiming position is determined on the basis of the detection result by the detection unit 37, the drift error of the gyro sensor included in the detection unit 37 can be corrected by the error correction unit 417. Thus, in a case where the operation mode of the operation device 3B is the second mode, the coordinate value of the aiming position can be determined with high accuracy.

### [Modifications of Embodiments]

The present disclosure is not limited to each embodiment described above, and modifications, improvements, and the like in the range that can achieve the object of the present disclosure are included in the present disclosure.

In each embodiment described above, the aiming position determination unit 412 or 416 determines the coordinate value of the aiming position in the display area DP of the display device 2. However, the present disclosure is not limited to this, and the aiming position determination unit 412 or 416 may determine the area numbers of a plurality of divided areas of the display area DP, instead of the coordinate value of the aiming position in the display area DP. That is, as long as the aiming position in the display area DP is uniquely determined, information indicating the aiming position may be any information.

In each embodiment described above, the first switching operation unit 36 is a button that can be operated by the thumb of the hand holding the grip 312. However, the present disclosure is not limited to this, and the first switching operation unit 36 may be any operation means that can be operated by the user and may be, for example, a touch sensor or a switch. Further, the position of the first switching operation unit 36 can be appropriately changed. For example, the first switching operation unit 36 may be provided on the first operation unit 32.

Further, the mode switching unit 411 or 415 switches the operation mode of the operation device 3A or 3B to the second mode in a case where the first switching operation unit 36 is operated. However, the mode switching unit 411 or 415 may switch the operation mode between the first mode and the second mode every time the first switching operation unit 36 is operated, instead of switching the operation mode to the second mode while the first switching operation unit 36 is being continuously operated. Meanwhile, the mode switching unit 411 or 415 may switch the operation mode of the operation device 3A or 3B to the first mode in a case where the first switching operation unit 36 is operated, instead of switching the operation mode to the second mode. Moreover, the first switching operation unit 36 may not be provided to the operation device 3B. In this case, in a case where no switching operation is performed on the second switching operation unit 43, the mode switching unit 415 may switch the operation mode of the operation device 3B to one of the first mode and the second mode.

In each embodiment described above, the aiming operation unit 321 is an analog stick. In the second embodiment described above, the aiming operation unit 331 is an analog stick. However, the present disclosure is not limited to this, and the aiming operation unit 321 or 331 may be any other operator such as the directional pad 322.

In each embodiment described above, the detection unit 37 includes an acceleration sensor configured to detect three-axis acceleration and a gyro sensor configured to detect three-axis angular velocity. However, the present disclosure is not limited to this, and the detection unit 37 may include other sensors capable of detecting the movement of the operation device 3A or 3B and may not include one of the acceleration sensor and the gyro sensor.

In the second embodiment described above, the second switching operation unit 43 includes a proximity sensor. However, the present disclosure is not limited to this, and the second switching operation unit 43 may be an operator such as a button or a slide switch that can be slid into three slide positions. Further, the placement position of the second switching operation unit 43 can also be appropriately changed.

Further, the mode switching unit 415 maintains the operation mode of the operation device 3B in the third mode while the proximity sensor of the second switching operation unit 43 continues to detect the user. However, the present disclosure is not limited to this, and the mode switching unit 415 may switch the operation mode to the third mode when the proximity sensor detects the user. Further, it is sufficient for the proximity sensor to detect the user, and the movement of the user detected by the proximity sensor is not limited to the movement of the user observing the display unit 44.

In the second embodiment described above, the mode switching unit 415 switches the operation mode of the operation device 3B to one of the first mode, the second mode, and the third mode, depending on switching operations by the user. However, the present disclosure is not limited to this, and the mode switching unit 415 may switch the operation mode of the operation device 3B to one of the first mode and the third mode, or one of the second mode and the third mode, depending on switching operations by the user. That is, the operation mode of the operation device 3B may not include one of the first mode and the second mode.

In the second embodiment described above, the operation device 3B includes the display unit 44 configured to display at least a part of the captured image obtained by the imaging unit 42. However, the present disclosure is not limited to this, and the display unit 44 may not be provided. Further, as described above, the display unit 44 may display the entire captured image.

In the second embodiment described above, the imaging unit 42 is provided at the distal end portion in the direction D1 of the barrel 311 of the housing 31 such that the imaging direction is parallel to the extending direction of the barrel 311. However, the present disclosure is not limited to this, and as long as the imaging unit 42 is provided such that the imaging direction is parallel to the extending direction of the barrel 311, the placement position of the imaging unit 42 can be appropriately changed. For example, the imaging unit 42 may be provided at a position opposite to the direction D1 on the barrel 311, or on the grip 312, the foregrip 313, or the bridge 314.

Further, the housing 31 is shaped like a gun. However, the present disclosure is not limited to this, and the shape of the housing 31 may be any other shape other than the gun-like shape.

In the second embodiment described above, the control unit 41B includes the error correction unit 417 configured to correct the drift error of the gyro sensor included in the detection unit 37 in a case where the operation mode of the operation device 3B is not the first mode in which the coordinate value of the aiming position is determined on the basis of the detection result by the detection unit 37, that is, in a case where the operation mode is the second mode or the third mode. However, the present disclosure is not limited to this, and the error correction unit 417 may not be provided. Further, as described above, the correction method for drift errors using the error correction unit 417 is not limited to the above-mentioned one, and other correction methods may be employed.

In each embodiment described above, the signal generation unit 413 generates an operation signal indicating the determined coordinate value of the aiming position, and the communication unit 38, which corresponds to the transmission unit, transmits the generated operation signal to the information processing device 5. However, the present disclosure is not limited to this, and when the processing of games or the like can be executed only by the operation device 3A or 3B, for example, it is not necessary to transmit operation signals to the outside. In this case, execution screens such as game screens may be displayed on the display unit 44. Further, in this case, the display device 2 and the information processing device 5 may not be provided.

In each embodiment described above, the information processing device 5 executes the processing of games or the like on the basis of operation signals received from the operation device 3A or 3B. However, the present disclosure is not limited to this. The information processing device 5 may be connected to a server via a network, the server may proceed the processing of a game or the like on the basis of operation signals received from the information processing device 5, and the information processing device 5 may cause the display device 2 to display execution screens such as game screens received from the server.

In each embodiment described above, the aiming operation processing that is performed by the control unit 41A or 41B is executed on the basis of the aiming operation program stored in the storage unit 39. Such an aiming operation program may be recorded on a recording medium in a computer-readable manner. By reading and executing the aiming operation program from such a recording medium by the operation device, it is possible to achieve effects similar to those of the operation device 3A or 3B described above. Such a recording medium may be a disk-type recording medium or a semiconductor storage device.

Besides, the aiming operation program may be provided via a network.

In each embodiment described above, the barrel 311, the grip 312, the foregrip 313, and the bridge 314 of the housing 31 are connected to each other. However, the present disclosure is not limited to this, and at least one of the barrel 311, the grip 312, the foregrip 313, and the bridge 314 may be detachably mounted to the housing 31. In this case, the part may be selected from a plurality of mounting bodies having different functions. That is, the operation device may be configured such that a mounting body having a predetermined function is selectively mounted to the housing for function expansion or shape change of the operation device.

### [Conclusion of Present Disclosure]

Now, the conclusion of the present disclosure is appended.

[1]

An operation device configured to operate an aiming position in response to an operation by a user, the operation device includes a first switching operation unit configured to receive an operation to switch an operation mode of the operation device, a detection unit configured to detect movement of the operation device, an aiming operation unit configured to operate the aiming position in response to an operation by the user, and a mode switching unit configured to switch, depending on an operation on the first switching operation unit, the operation mode to one of a first mode in which the aiming position is determined on the basis of movement of the operation device detected by the detection unit and a second mode in which the aiming position is determined on the basis of an operation on the aiming operation unit.

With such a configuration, the aiming position can be determined on the basis of the movement of the operation device detected by the detection unit, and the aiming position can also be determined on the basis of an operation on the aiming operation unit. With this, there is no need to provide an imaging device for acquiring the posture of the operation device and the relative orientation between the operation device and the display device by imaging the operation device. Thus, the aiming position can be determined without requiring complex configuration or operation. Then, an operation signal indicating the determined aiming position is transmitted by the operation device, and the operated aiming position can thus be grasped by the information processing device that has received the operation signal.

[2]

In [1], the operation device may further include a second switching operation unit configured to receive an operation to switch the operation mode, and an imaging unit configured to capture an area in which the aiming position is set. The mode switching unit may switch, when the second switching operation unit is operated, the operation mode to a third mode in which the aiming position is determined on the basis of a captured image obtained by the imaging unit. The mode switching unit may switch, when the second switching operation unit is not operated, the operation mode to one of the first mode and the second mode depending on an operation on the first switching operation unit.

With such a configuration, the aiming position is determined on the basis of the captured image obtained by the imaging unit, so that the aiming position can be determined with high accuracy.

[3]

In the operation device according to [2], the operation device may further include a display unit configured to display at least a part of a captured image obtained by the imaging unit.

With such a configuration, it is possible to make it easier for the user to recognize the aiming position operated by the user by changing the posture of the operation device. Thus, the usability of the operation device can be enhanced.

[4]

In the operation device according to [3], the second switching operation unit may include a proximity sensor provided in a vicinity of the display unit and configured to detect the user, and the mode switching unit may switch the operation mode to the third mode when movement of the user observing the display unit is detected by the second switching operation unit.

With such a configuration, the second switching operation unit can regard the movement of the user looking into the display unit as the movement of the user looking into the rear sight of a gun and recognize the movement as an operation to switch the operation mode of the operation device to the third mode in which the imaging unit configured to capture an image, a part of which is displayed on the display unit, is used. Then, in a case where the operation is performed on the second switching operation unit, the operation mode of the operation device is switched to the third mode in which the aiming position is determined on the basis of the captured image obtained by the imaging unit, which makes it possible to operate the operation device as if using an actual gun. Thus, the usability of the operation device can be enhanced.

[5]

In the operation device according to any one of [2] to [4], the operation device may further include a gun-shaped housing configured to form an exterior of the operation device. The imaging unit may be provided on a barrel of the housing such that an imaging direction of the imaging unit extends along an extending direction of the barrel.

With such a configuration, since the imaging unit is provided on the barrel of the housing such that the imaging direction extends along the extending direction of the barrel, it is possible to make it easier to match the aiming position determined on the basis of the captured image obtained by the imaging unit with the aiming position recognized by the user on the basis of the shape of the operation device. That is, it is possible to make it easier for the user to intuitively operate the operation device when moving the aiming position. Thus, the usability of the operation device can be enhanced.

[6]

In the operation device according to any one of [2] to [5], the operation device may further include an error correction unit configured to correct an error of a gyro sensor included in the detection unit, when the operation mode is not the first mode.

With such a configuration, in a case where the operation mode of the operation device is not the second mode in which the aiming position is determined on the basis of the detection result by the detection unit, the error, such as the drift error, of the gyro sensor included in the detection unit can be corrected by the error correction unit. Thus, in a case where the operation mode of the operation device is the second mode, the aiming position can be determined with high accuracy.

[7]

In the operation device according to any one of [1] to [6], the operation device may further include a signal generation unit configured to generate a signal indicating a determined coordinate value of the aiming position, and a transmission unit configured to transmit a signal generated by the signal generation unit. With such a configuration, external equipment different from the operation device can grasp the aiming position operated by the operation device by receiving the transmitted operation signal.

[8]

An operation system according to a second aspect of the present disclosure includes the operation device of any one of [1] to [7], and an information processing device that is operated by the operation device.

With such a configuration, it is possible to achieve effects similar to those of the operation device described above.

[9]

In the operation system according to [8], the operation system may further include a display device configured to display a screen which is generated by the information processing device and in which the aiming position is operated by the operation device.

With such a configuration, since the display device on which the aiming position is operated displays images generated by the information processing device, by acquiring the aiming position determined by the operation device, for example, the information processing device can cause the display device to display an aiming marker indicating the aiming position. Thus, the versatility of the operation system can be enhanced.

An operation method according to a third aspect of the present disclosure is performed by an operation device configured to operate an aiming position, and the operation method includes a first determination procedure of determining whether or not a first switching operation to switch an operation mode of the operation device has been performed, a first switching procedure of switching, when it is determined, in the first determination procedure, that the first switching operation has been performed, the operation mode of the operation device to one of a first mode in which the aiming position is determined on the basis of movement of the operation device, and a second mode in which the aiming position is determined on the basis of an operation by a user on an aiming operation unit provided on the operation device, and a second switching procedure of switching, when it is determined, in the first determination procedure, that the first switching operation has not been performed, the operation mode of the operation device to another mode of the first mode and the second mode.

With such a configuration, it is possible to achieve effects similar to those of the operation device according to [1].

The operation method according to further includes a second determination procedure of determining whether or not a second switching operation to switch the operation mode of the operation device has been performed, and a third switching procedure of switching, when it is determined, in the second determination procedure, that the second switching operation has been performed, the operation mode of the operation device to a third mode in which the aiming position is determined on the basis of a captured image obtained by an imaging unit provided on the operation device, in which the first determination procedure is performed when it is determined, in the second determination procedure, that the second switching operation has not been performed.

With such a configuration, it is possible to achieve effects similar to those of the operation device according to [2].

The operation method according to further includes a display procedure of causing, when the operation mode of the operation device is switched to the third mode, a display unit provided on the operation device to display at least a part of a captured image obtained by the imaging unit.

With such a configuration, it is possible to achieve effects similar to those of the operation device according to [3].

### REFERENCE SIGNS LIST

1: Information processing system (operation system)
2: Display device
3A, 3B: Operation device
31: Housing
311: Barrel
312: Grip
313: Foregrip
314: Bridge
321, 331: Aiming operation unit
36: First switching operation unit
37: Detection unit
38: Communication unit (transmission unit)
41A, 41B: Control unit
411, 415: Mode switching unit
412, 416: Aiming position determination unit
413: Signal generation unit
414: Communication control unit
417: Error correction unit
42: Imaging unit
43: Second switching operation unit
44: Display unit
5: Information processing device
SA1, SB3: Step (first determination procedure)
SA2, SB6: Step (second mode switching procedure)
SA3, SB4: Step (first mode switching procedure)
SB1: Step (second determination procedure)
SB2: Step (third mode switching procedure).

The invention claimed is:

1: An operation device configured to operate an aiming position in response to an operation by a user, the operation device comprising:
a first switching operation unit configured to receive an operation to switch an operation mode of the operation device;
a detection unit configured to detect movement of the operation device;
an aiming operation unit configured to operate the aiming position in response to an operation by the user; and
a mode switching unit configured to switch, depending on an operation on the first switching operation unit, the operation mode to one of a first mode in which the aiming position is determined on a basis of movement of the operation device detected by the detection unit and a second mode in which the aiming position is determined on a basis of an operation on the aiming operation unit.

2: The operation device according to claim 1, further comprising:
a second switching operation unit configured to receive an operation to switch the operation mode; and
an imaging unit configured to capture an area in which the aiming position is set, wherein
the mode switching unit switches, when the second switching operation unit is operated, the operation mode to a third mode in which the aiming position is determined on a basis of a captured image obtained by the imaging unit, and
the mode switching unit switches, when the second switching operation unit is not operated, the operation mode to one of the first mode and the second mode depending on an operation on the first switching operation unit.

3: The operation device according to claim 2, further comprising:
a display unit configured to display at least a part of a captured image obtained by the imaging unit.

4: The operation device according to claim 3, wherein
the second switching operation unit includes a proximity sensor provided in a vicinity of the display unit and configured to detect the user, and
the mode switching unit switches the operation mode to the third mode when movement of the user observing the display unit is detected by the second switching operation unit.

5: The operation device according to claim 2, further comprising:
a gun-shaped housing configured to form an exterior of the operation device, wherein
the imaging unit is provided on a barrel of the housing such that an imaging direction of the imaging unit extends along an extending direction of the barrel.

6: The operation device according to claim 2, further comprising:
an error correction unit configured to correct an error of a gyro sensor included in the detection unit, when the operation mode is not the first mode.

7: The operation device according to claim 1, further comprising:
a signal generation unit configured to generate a signal indicating a determined coordinate value of the aiming position; and
a transmission unit configured to transmit a signal generated by the signal generation unit.

8: An operation system comprising:
an operation device configured to operate an aiming position in response to an operation by a user, the operation device including
a first switching operation unit configured to receive an operation to switch an operation mode of the operation device,
a detection unit configured to detect movement of the operation device,
an aiming operation unit configured to operate the aiming position in response to an operation by the user; and
a mode switching unit configured to switch, depending on an operation on the first switching operation unit, the operation mode to one of a first mode in which the aiming position is determined on a basis of movement of the operation device detected by the detection unit and a second mode in which the aiming position is determined on a basis of an operation on the aiming operation unit; and
an information processing device that is operated by the operation device.

9: The operation system according to claim 8, further comprising:
a display device configured to display a screen which is generated by the information processing device and in which the aiming position is operated by the operation device.

10: An operation method that is performed by an operation device configured to operate an aiming position, the operation method comprising:
first determination of determining whether or not a first switching operation to switch an operation mode of the operation device has been performed;
first switching of switching, when it is determined, in the first determination, that the first switching operation has been performed, the operation mode of the operation device to one of a first mode in which the aiming position is determined on a basis of movement of the operation device, and a second mode in which the aiming position is determined on a basis of an operation by a user on an aiming operation unit provided on the operation device; and
second switching of switching, when it is determined, in the first determination, that the first switching operation has not been performed, the operation mode of the operation device to another mode of the first mode and the second mode.

11: The operation method according to claim 10, further comprising:
second determination of determining whether or not a second switching operation to switch the operation mode of the operation device has been performed; and
third switching of switching, when it is determined, in the second determination, that the second switching operation has been performed, the operation mode of the operation device to a third mode in which the aiming position is determined on a basis of a captured image obtained by an imaging unit provided on the operation device, wherein
the first determination procedure is performed when it is determined, in the second determination, that the second switching operation has not been performed.

12: The operation method according to claim 11, further comprising:
display of causing, when the operation mode of the operation device is switched to the third mode, a display unit provided on the operation device to display at least a part of a captured image obtained by the imaging unit.
